(19) United States
(12) Patent Application Publication
(10) Pub. No.: US 2022/0130246 A1
(43) Pub. Date: Apr. 28, 2022

(54) OPERATION MANAGEMENT METHOD, SERVER, AND SYSTEM

(71) Applicant: TOYOTA JIDOSHA KABUSHIKI KAISHA, Toyota-shi (JP)

(72) Inventors: Hiroshi HIGASHIDE, Nagoya-shi (JP); Keiichi UNO, Chita-gun (JP)

(73) Assignee: TOYOTA JIDOSHA KABUSHIKI KAISHA, Toyota-shi (JP)

(21) Appl. No.: 17/507,603

(22) Filed: Oct. 21, 2021

(30) Foreign Application Priority Data
Oct. 22, 2020 (JP) 2020-177615

(51) Int. Cl. G08G 1/13; G08G 1/00; H04W 4/40

(52) U.S. Cl. CPC G08G 1/13; H04W 4/40; G08G 1/202

(57) ABSTRACT

An operation management method for a plurality of circulating buses, each circulating bus being introduced into a circulation route from a base and returning to the base to be switched with another circulating bus after traveling a specified number of laps, includes storing, by a server, an operation schedule of the plurality of circulating buses, monitoring, by the server, a status of the plurality of circulating buses, judging, by the server, whether a first circulating bus traveling on the circulation route is on a final lap in the specified number of laps when the first circulating bus passes a second circulating bus traveling on the circulation route, and revising, by the server, the operation schedule to increase the number of circulating buses by introducing a third circulating bus into the circulation route from the base when it is judged that the first circulating bus is on the final lap.

### CROSS-REFERENCE TO RELATED APPLICATION

This application claims priority to Japanese Patent Application No. 2020-177615, filed on Oct. 22, 2020, the entire contents of which are incorporated herein by reference.

### TECHNICAL FIELD

The present disclosure relates to an operation management method, a server, and a system.

### BACKGROUND

Technology for managing the operation of a plurality of vehicles is known. For example, patent literature (PTL) 1 discloses an autonomous vehicle that circulates along a travel route provided by a management center.

### CITATION LIST

### Patent Literature

PTL 1: JP 2020-013379 A

### SUMMARY

When a circulating bus travels a specified number of laps on a circulation route, the operation schedule can be determined so that the circulating bus is returned to a base and systematically switched with another circulating bus on standby so that, for example, operations such as refueling and maintenance can be performed on the circulating bus. However, if a delay occurs for some reason in a circulating bus A during travel, the circulating bus A might be passed by a following circulating bus B. Here, if the passing circulating bus B is on the final lap of the circulation route, the bus stop before the base on the circulation route becomes the last stop for the circulating bus B.

Consider, for example, a situation in which a passenger who wishes to ride to a bus stop ahead of the base is waiting at the bus stop for the circulating bus A scheduled to arrive next. In such a situation, if the circulating bus B arrives at the bus stop before the circulating bus A, the passenger must refrain from boarding the circulating bus B that arrived first. At this time, passengers may feel that the supply of circulating buses is insufficient to meet demand, due to their dissatisfaction with the delay of the circulating bus A and further dissatisfaction with having to refrain from boarding a circulating bus. Therefore, there is room for improvement in technology for managing the operation of a plurality of vehicles.

It would be helpful to improve technology for managing operation of a plurality of vehicles.

An operation management method according to an embodiment of the present disclosure is an operation management method for a plurality of circulating buses, each circulating bus being introduced into a circulation route from a base and returning to the base to be switched with another circulating bus after traveling a specified number of laps, the operation management method including:

storing, by a server, an operation schedule of the plurality of circulating buses;

monitoring, by the server, a status of the plurality of circulating buses;

judging, by the server, whether a first circulating bus traveling on the circulation route is on a final lap in the specified number of laps when the first circulating bus passes a second circulating bus traveling on the circulation route; and

revising, by the server, the operation schedule to increase the number of circulating buses by introducing a third circulating bus into the circulation route from the base when it is judged that the first circulating bus is on the final lap.

A server according to an embodiment of the present disclosure is a server for managing a plurality of circulating buses, each circulating bus being introduced into a circulation route from a base and returning to the base to be switched with another circulating bus after traveling a specified number of laps, the server including a controller configured to:

store an operation schedule of the plurality of circulating buses;

monitor a status of the plurality of circulating buses;

judge whether a first circulating bus traveling on the circulation route is on a final lap in the specified number of laps when the first circulating bus passes a second circulating bus traveling on the circulation route; and

revise the operation schedule to increase the number of circulating buses by introducing a third circulating bus into the circulation route from the base when it is judged that the first circulating bus is on the final lap.

A system according to an embodiment of the present disclosure is a system for including a plurality of circulating buses, each circulating bus being introduced into a circulation route from a base and returning to the base to be switched with another circulating bus after traveling a specified number of laps, and a server for managing operation of the plurality of circulating buses, wherein

the server is configured to store an operation schedule of the plurality of circulating buses;

the plurality of circulating buses operates in accordance with the operation schedule;

the server is configured to
monitor a status of the plurality of circulating buses;
judge whether a first circulating bus traveling on the circulation route is on a final lap in the specified number of laps when the first circulating bus passes a second circulating bus traveling on the circulation route; and

revise the operation schedule to increase the number of circulating buses by introducing a third circulating bus into the circulation route from the base when it is judged that the first circulating bus is on the final lap; and

the plurality of circulating buses operates in accordance with the revised operation schedule.

According to an embodiment of the present disclosure, technology for managing the operation of a plurality of vehicles is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a diagram illustrating an overview of a transportation service according to an embodiment of the present disclosure;

FIG. 3 is a diagram illustrating an example of an operation schedule;

FIG. 4 illustrates an example of a situation in which passing by a vehicle traveling on the final lap has occurred;

FIG. 5 is a block diagram illustrating a schematic configuration of a vehicle;

FIG. 6 is a block diagram illustrating a schematic configuration of a server; and

FIG. 7 is a flowchart illustrating operations of the server.

### DETAILED DESCRIPTION

Hereinafter, an embodiment of the present disclosure will be described.

(Summary of Embodiment)

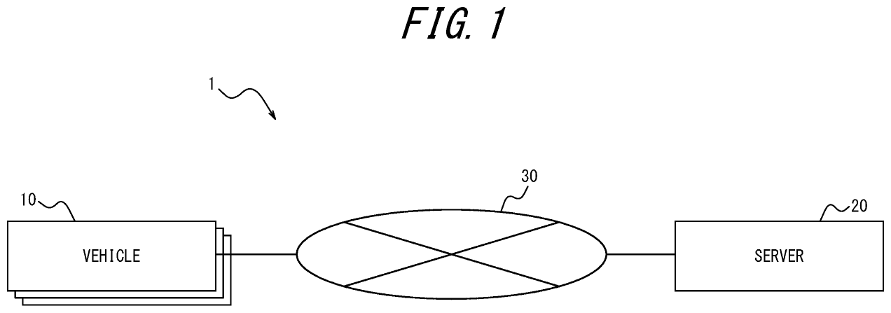

An outline of a system 1 according to an embodiment of the present disclosure will be described with reference to FIG. 1. The system 1 includes a plurality of vehicles 10 and a server 20. The plurality of vehicles 10 and the server 20 can communicate with each other via a network 30 including, for example, the Internet and a mobile communication network. The vehicle 10 is, for example, a passenger automobile such as a bus, but the vehicle 10 is not limited to this and may be any vehicle that a person can board. The vehicle 10 may be capable of automated driving such as any one of Level 1 to Level 5 as defined by the Society of Automotive Engineers (SAE), for example. The server 20 is, for example, an information processing apparatus such as a computer.

In the present embodiment, the plurality of vehicles 10 are used as circulating buses that travel over a circulation route. The server 20 manages the operation of the plurality of vehicles 10 by notifying the plurality of vehicles 10 of an operation schedule. The plurality of vehicles 10 operate in accordance with the operation schedule notified by the server 20.

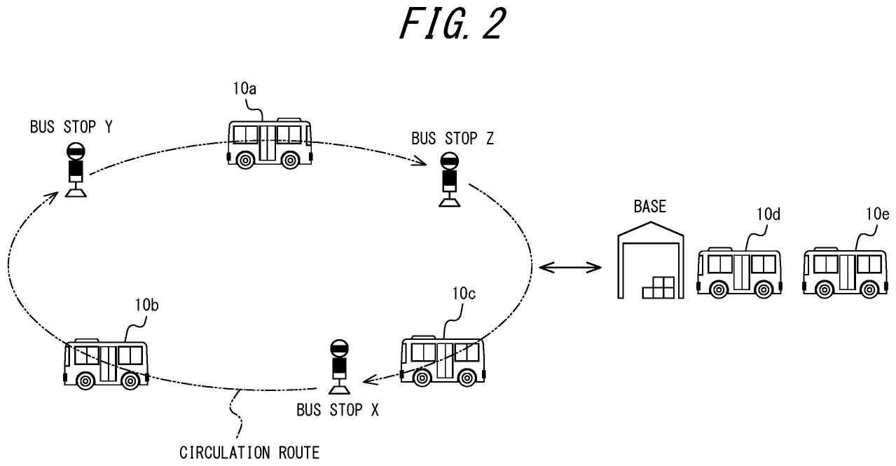

With reference to FIG. 2, an overview of operations of each vehicle 10 that operates in accordance with the operation schedule will be described. When introduced into the circulation route from a base, each vehicle 10 can travel clockwise along the circulation route while allowing passengers to get on and off at each bus stop among bus stops X to Z on the circulation route. In FIG. 2, three vehicles 10a to 10c are traveling on the circulation route. When each vehicle 10 has traveled a specified number of laps n (n is a natural number equal to or greater than 2, and n=4 laps in the present embodiment) after being introduced into the circulation route, the vehicle 10 returns to the base and switches with another vehicle 10 on standby. Here, “switches” indicates that the vehicle 10 returns to the base from the circulation route and that the other vehicle 10 on standby is introduced into the circulation route from the base. The switching of a vehicle 10 with another vehicle 10 on standby is also referred to below as “normal switching”. In FIG. 2, two vehicles 10d, 10e are on standby at the base. Each vehicle 10 returns to the base from the circulation route and waits at the base after undergoing operations such as refueling and maintenance, for example.

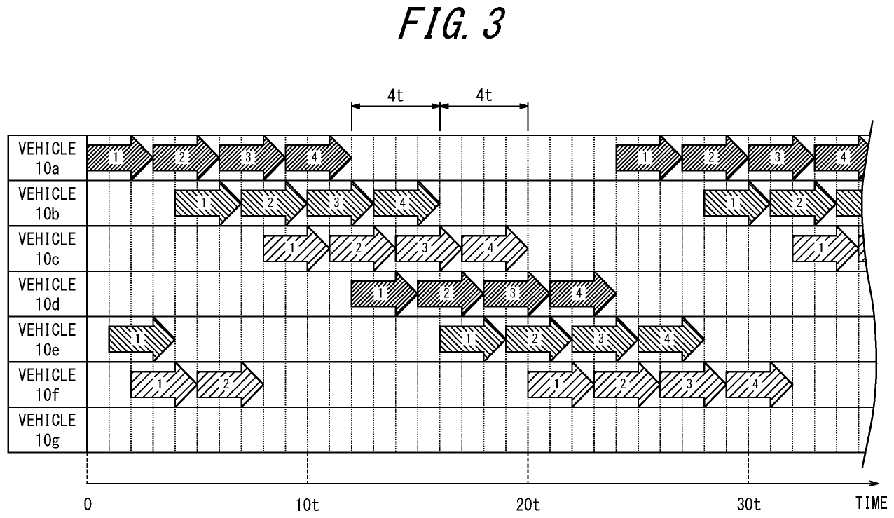

With reference to FIG. 3, the operation schedule will be explained in detail. FIG. 3 illustrates the operation schedule assigned to each of seven vehicles 10a to 10g. The horizontal axis in FIG. 3 indicates the time. Time=0 is an operation start time of the transportation service using the plurality of vehicles 10. The time periods depicted with a rightward arrow indicate that the vehicle 10 is traveling on the circulation route. The length of the arrow indicates the time (3t in the present embodiment) required for the vehicle 10 to travel one lap on the circulation route. The numerical value inside the arrow indicates the number of the lap that the vehicle 10 is on after introduction into the circulation route. The time corresponding to the left end of the arrow with the number “1” inside indicates the time when the vehicle 10 is introduced into the circulation route from the base. The time corresponding to the right end of an arrow indicates the time at which the vehicle 10 returns to the base from the circulation route if there is no continuous next arrow to the right of the arrow.

When the operation schedule illustrated in FIG. 3 is applied, the vehicle 10a is introduced into the circulation route from the base at time=0, and when the vehicle 10a completes the specified number of laps n (here, n=4 laps) at time=12t, the vehicle 10a returns to the base and is switched with the vehicle 10d on standby, for example. The vehicle 10d is introduced into the circulation route from the base at time=12t, returns to the base at time=24t after completing the specified number of laps n (here, n=4 laps), and is switched with the vehicle 10a on standby. In this way, the vehicles 10a and 10g operate while switching with each other. Similarly, the vehicles 10b and 10e operate while switching with each other, and the vehicles 10c and 10f operate switching turns with each other. Here, the vehicle 10b is introduced into the circulation route at time=4t, and the vehicle 10c is introduced into the circulation route at time=8t.

Consequently, according to the operation schedule, the number of vehicles 10 traveling on the circulation route is maintained at the specified number (in this case, a=3) from time=8t onwards. From time=8t onwards, “a” vehicles 10 traveling on the circulation route are arranged at substantially equal intervals on the circulation route. The above-described normal switching also occurs once in a specified period P (here, P=4t) from time=12t onwards. Also, from time=8t onwards, a plurality of vehicles 10 are not on the same lap simultaneously among the “a” vehicles 10 traveling on the circulation route (i.e., the number of the lap being traveled differs for each of the “a” vehicles 10 traveling on the circulation route). For example, vehicles 10a, 10b, and 10c, which are traveling on the circulation route at time=8t, are traveling on their third, second, and first laps, respectively. Since a plurality of vehicles 10 are not on the same lap simultaneously, the specified period P can be longer than the time required for the vehicle 10 to make one lap of the circulation route (in this case, 3t). By lengthening the specified period P in which the normal switching occurs, the frequency with which the vehicles 10 return to the base from the circulation route (for example, the frequency with which regular switching occurs) is reduced, thereby increasing the time available for operations such as refueling and maintenance to be performed on the vehicles 10 that return to the base.

As an exception, the vehicle 10e is introduced into the circulation route at time=t and is switched with the vehicle 10b at time=4t. As an exception, the vehicle 10f is introduced into the circulation route at time=2t and is switched with the vehicle 10c at time=8t.

Consequently, according to the operation schedule, the number of vehicles 10 traveling on the circulation route is maintained at the specified number (in this case, a=3) from time=2t onwards. From time=2t onwards, “a” vehicles 10 traveling on the circulation route are arranged at substantially equal intervals on the circulation route. The above-described normal switching occurs once in each specified period P (here, P=4t) from time=4t onwards. Note that during a certain time period (here, the period from time=0 to time=8t) from the operation start time of the transportation service, a plurality of vehicles 10 are on the same lap simultaneously on an exceptional basis. For example, the vehicles 10a and 10f, which are on the circulation route at time=5t, are both on their second lap. However, in order for the cycle in which the normal switching occurs to be maintained as the specified period P (here, P=4t), the vehicles 10e and 10f that are exceptionally introduced during the certain time period are switched with the vehicles 10b and 10c, respectively, before completing the specified number of laps n (here, n=4 laps).

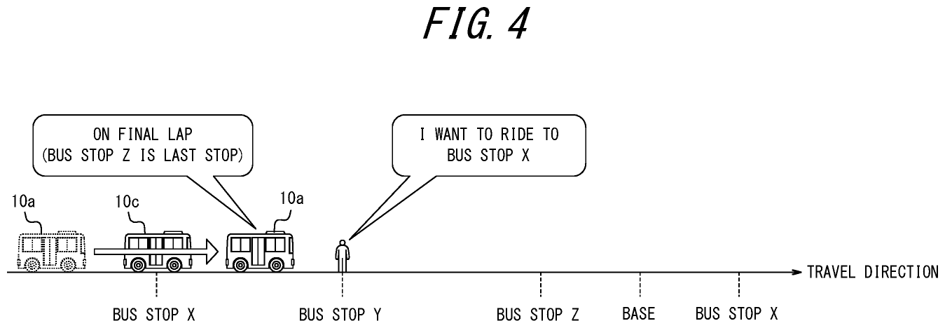

With reference to FIG. 4, a case in which passing occurs between two vehicles 10 will be described. The horizontal axis in the figure indicates the direction of travel of the vehicles 10 on the circulation route. In the example illustrated in FIG. 4, the vehicle 10c, which is stopped at bus stop X, is delayed for a reason such as it taking time for a bus attendant to assist passengers in getting on and off the vehicle. On the other hand, the vehicle 10a, which is traveling according to the operation schedule without delay, passes the delayed vehicle 10c and heads toward bus stop Y.

Here, the vehicle 10a is on the final lap (here, the fourth lap) of the specified number of laps n (here, n=4 laps). Therefore, the last stop for vehicle 10a is bus stop Z. In other words, after all passengers have gotten off the vehicle 10a at bus stop Z, the vehicle 10a is scheduled to be switched with another vehicle 10d at the base, without traveling to bus stop X. On the other hand, the vehicle 10c is not on the final lap (here, the fourth lap) of the specified number of laps n (here, n=4 laps), but rather is on the first lap, for example. Therefore, when the vehicle 10c passes the base, it is scheduled to start the second lap and head towards bus stop X.

A passenger who wishes to ride to bus stop X ahead of the base is waiting at bus stop Y for the vehicle 10 scheduled to arrive next. In such a situation, if the vehicle 10a arrives at bus stop Y before the vehicle 10c, the passenger must refrain from boarding the vehicle 10a, whose last stop is bus stop Z, and wait for the vehicle 10c to arrive. At this time, passengers may feel that the supply of vehicles 10 is insufficient to meet demand, due to their dissatisfaction with the delay of the vehicle 10c and further dissatisfaction with having to refrain from boarding the vehicle 10a that arrived first at the bus stop Y.

In contrast, the server 20 of the present embodiment stores the operation schedule of a plurality of vehicles 10. The server 20 monitors the status of the plurality of vehicles 10. When the vehicle 10a traveling on the circulation route passes the vehicle 10c traveling on the circulation route, the server 20 judges whether the vehicle 10a is on the final lap in the specified number of laps n. When the server 20 judges that the vehicle 10a is on the final lap, the server 20 revises the operation schedule to increase the number of vehicles by, for example, introducing another vehicle 10 that is on standby at the base (such as the vehicle 10g illustrated in FIG. 3) into the circulation route from the base.

According to such a configuration, when passing by a vehicle 10 on the final lap in the specified number of laps n occurs, a vehicle 10 on standby at the base (such as the vehicle 10g illustrated in FIG. 3) is additionally introduced into the circulation route, thereby increasing the number of vehicles. Accordingly, technology for managing the operation of a plurality of vehicles 10 is improved in that passenger dissatisfaction can be reduced by an increase in the supply of vehicles 10 in a transportation service.

Next, configurations of the system 1 will be described in detail.

(Configuration of Vehicle)

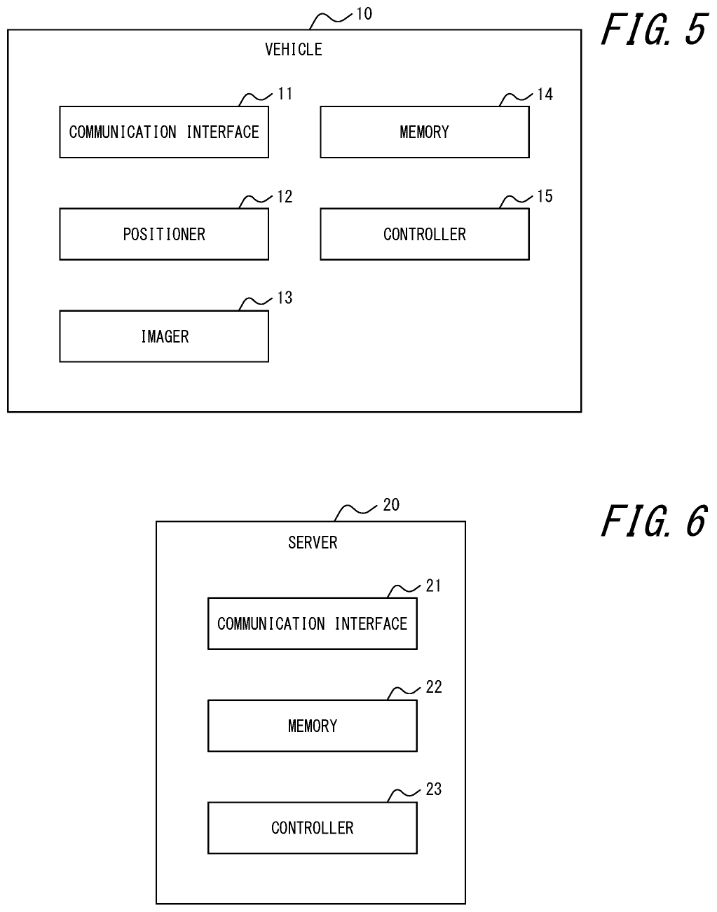

As illustrated in FIG. 5, the vehicle 10 includes a communication interface 11, a positioner 12, an imager 13, a memory 14, and a controller 15.

The communication interface 11 includes at least one communication interface for connecting to the network. The communication interface is compliant with mobile communication standards such as the 4th generation (4G) standard or the 5th generation (5G) standard, for example, but these examples are not limiting. In the present embodiment, the vehicle 10 communicates with the server 20 via the communication interface 11 and the network 30.

The positioner 12 includes one or more apparatuses configured to acquire positional information for the vehicle 10. Specifically, the positioner 12 includes, for example, a receiver compliant with GPS, but is not limited to this example and may include a receiver compliant with any appropriate satellite positioning system.

The imager 13 includes one or more cameras. Each camera included in the imager 13 may be installed in the vehicle 10 so as to be able to capture a subject outside or inside the vehicle, for example. The images generated by the imager 13 can, for example, be used for autonomous driving control of the vehicle 10.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information used for operations of the vehicle 10. For example, the memory 14 may store a system program, an application program, embedded software, and the like. The information stored in the memory 14 may be updated with, for example, information acquired from the network 30 via the communication interface 11.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire vehicle 10. For example, the controller 15 controls the operations of the vehicle 10 according to the operation schedule notified by the server 20.

(Configuration of Server)

As illustrated in FIG. 6, the server 20 includes a communication interface 21, a memory 22, and a controller 23.

The communication interface 21 includes at least one communication interface for connecting to the network 30. The communication interface may be compliant with, for example, mobile communication standards, wired local area network (LAN) standards, or wireless LAN standards, but these examples are not limiting. The communication interface may be compliant with any appropriate communication standards. In the present embodiment, the server 20 communicates with the vehicle 10 via the communication interface 21.

The memory 22 includes one or more memories. The memories included in the memory 22 may each function as, for example, a main memory, an auxiliary memory, or a cache memory. The memory 22 stores any information used for operations of the server 20. For example, the memory 22 may store a system program, an application program, a database, map information, the operation schedule of the plurality of vehicles 10, and the like. The information stored in the memory 22 may be updated with, for example, information acquired from the network 30 via the communication interface 21.

The controller 23 includes at least one processor, at least one programmable circuit, at least one dedicated circuit, or a combination of these. The controller 23 controls the operations of the entire server 20. Details of the operations of the server 20 controlled by the controller 23 will be described later.

(Server Operation Flow)

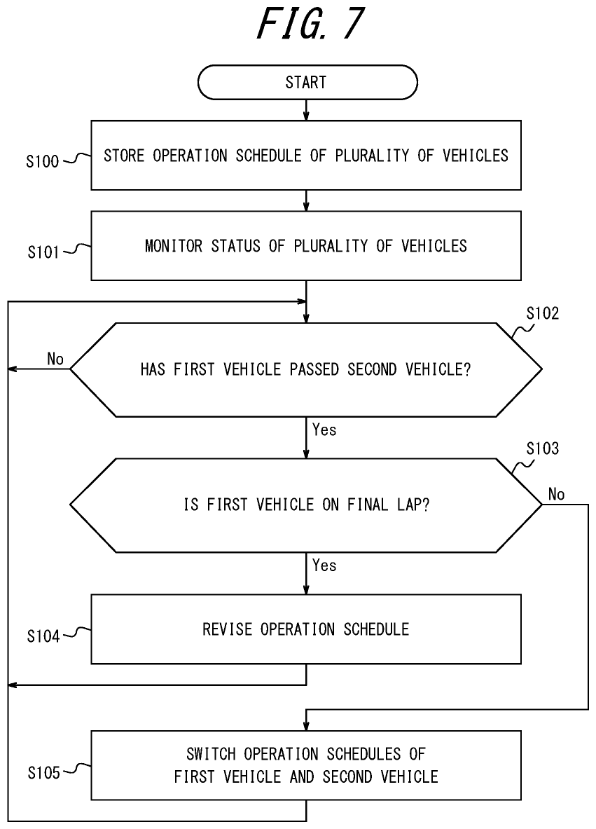

With reference to FIG. 7, operations of the server 20 according to the present embodiment will be described.

Step S100: The controller 23 of the server 20 stores the operation schedule of the plurality of vehicles 10 in the memory 22. The operation schedule may, for example, be generated automatically by the controller 23, inputted by an operator, or acquired from an external apparatus via the communication interface 21 and the network 30.

Details are now provided in accordance with the example illustrated in FIG. 3. As described above, the operation schedule stored in step S100 is determined so that the number of vehicles 10 traveling on the circulation route is maintained at a specified number of vehicles a (here, a=3), except for a certain time period (here, the period from time=0 to time=2t) from the operation start time of the transportation service that uses the plurality of vehicles 10. The operation schedule is also determined so that the “a” vehicles 10 traveling on the circulation route are arranged at substantially equal intervals on the circulation route, except for a certain time period (in this case, the period from time=0 to time=2t) from the operation start time. The operation schedule is also determined so that a plurality of vehicles 10 are not on the same lap simultaneously, except for a certain time period (in this case, the period from time=0 to time=8t) from the operation start time. Furthermore, the operation schedule is determined so that the switching between a vehicle 10 that has completed the specified number of laps n (here, n=4 laps) and another vehicle 10 occurs once in a specified period P (here, P=4t).

Step S101: The controller 23 starts monitoring the status of the plurality of vehicles 10.

Specifically, the controller 23 is communicably connected to each vehicle 10 via the communication interface 21 and the network 30. The controller 23 notifies the plurality of vehicles 10 of the operation schedule of step S100. Each vehicle 10 operates in accordance with the operation schedule notified by the server 20. The controller 23 then monitors the status of each vehicle 10 by receiving vehicle information from each vehicle 10 periodically or at any appropriate timing, for example. The vehicle information includes positional information for the vehicle 10, but this example is not limiting. The vehicle information may include any appropriate information about the vehicle 10, such as the speed of the vehicle 10, information indicating deviation from the operation schedule (such as delay time), and information indicating that another vehicle 10 has been passed.

Step S102: The controller 23 judges, based on the vehicle information acquired from the plurality of vehicles 10 during the monitoring, whether a first vehicle 10 traveling on the circulation route has passed a second vehicle 10. When it is judged that the first vehicle 10 has passed the second vehicle 10 (step S102: Yes), the process advances to step S103. Conversely, when it is judged that the first vehicle 10 has not passed the second vehicle 10, the process repeats step S102.

Step S103: When it is judged in step S102 that the first vehicle 10 has passed the second vehicle 10 (step S102: Yes), the controller 23 judges whether the first vehicle 10 is on the final lap in the specified number of laps n. When it is judged that the first vehicle 10 is on the final lap (step S103: Yes), the process proceeds to step S104. Conversely, when it is judged that the first vehicle 10 is not on the final lap (step S103: No), the process returns to step S102.

Step S104: when it is judged in step S103 that the first vehicle 10 is on the final lap (step S103: Yes), the controller 23 revises the operation schedule stored in step S100. The process subsequently returns to step S102.

Specifically, the controller 23 revises the operation schedule to increase the number of vehicles by introducing a third vehicle 10, which is on standby at the base, into the circulation route from the base. The controller 23 revises the operation schedule to maintain the number of vehicles 10 traveling on the circulation route at a+1 (where a is the specified number of vehicles). The controller 23 also revises the operation schedule so that the a+1 vehicles 10 that are traveling on the circulation route are arranged at substantially equal intervals on the circulation route by the point at which a predetermined time has elapsed from the timing at which the third vehicle 10 is introduced into the circulation route.

Step S105: When it is judged in step S103 that the first vehicle 10 is not on the final lap (step S103: No), the controller 23 switches the operation schedule assigned to the first vehicle 10 with the operation schedule assigned to the second vehicle 10. The process subsequently returns to step S102.

As described above, the server 20 of the present embodiment stores the operation schedule of a plurality of vehicles 10. The server 20 monitors the status of the plurality of vehicles 10. When the first vehicle 10 traveling on the circulation route passes the second vehicle 10 traveling on the circulation route, the server 20 judges whether the first vehicle 10 is on the final lap in the specified number of laps n. When the server 20 judges that the vehicle 10 is on the final lap, the server 20 revises the operation schedule to increase the number of vehicles by introducing the third vehicle 10 into the circulation route from the base.

According to this configuration, when passing by a vehicle 10 on the final lap in the specified number of laps n occurs, the number of vehicles is increased by the third vehicle 10 being additionally introduced into the circulation route. Accordingly, technology for managing the operation of a plurality of vehicles 10 is improved in that passenger dissatisfaction can be reduced by an increase in the supply of vehicles 10 in a transportation service.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the server 20 in the above embodiment are distributed to a plurality of information processing apparatuses capable of communicating with each other can also be implemented. For example, an embodiment in which some or all of the components of the server 20 are provided in the vehicle 10 can also be implemented.

In the above embodiment, when the operation schedule is revised, the controller 23 of the server 20 may notify a terminal apparatus, provided at one or more bus stops located on the circulation route, that the number of vehicles 10 traveling on the circulation route has increased. In greater detail, a terminal apparatus provided with an output interface such as a display, an electronic message board, or a speaker, for example, is installed at each bus stop. The controller 23 notifies the terminal apparatus, via the communication interface 21 and the network 30, of the increase in the number of vehicles 10 traveling on the circulation route and the timetable after the increase. Here, the controller 23 may, for example, notify the terminal apparatus provided at the next bus stop from the point where passing occurred on the circulation route or may notify the terminal apparatus provided at each bus stop. The terminal apparatus provides output, via the output interface, to the passengers waiting at the bus stop to indicate the increase in the number of vehicles 10 traveling on the circulation route and the timetable after the increase. According to this configuration, passengers waiting at the bus stop can immediately recognize that the number of vehicles has been increased, which increases the probability that passenger dissatisfaction will be reduced.

In the above embodiment, for example, if passing by a vehicle 10 traveling on the final lap occurs more than once in a relatively short period of time, the number of vehicles need not necessarily be increased each time passing occurs. For example, an upper limit may be set on the increase in the number of vehicles during a certain time period going back from the current time (such as the time period from the current time to 3t ago in the case where the time required for the vehicle 10 to travel one lap of the circulation route is 3t). If passing by a vehicle 10 on the final lap occurs multiple times in a relatively short period of time, and the number of vehicles is increased each time passing occurs, the number of vehicles 10 on standby at the base might become less than planned or reach zero. In such a case, inconveniences such as an inability to implement the scheduled normal switching may occur. The above-described configuration for setting an upper limit on the number of boardable vehicles 10, however, reduces the probability of such inconveniences occurring.

In the above embodiment, when passing by a vehicle 10 traveling on the final lap occurs, and another vehicle 10 is introduced into the circulation route from the base to increase the number of vehicles, the controller 23 may judge whether any of the vehicles 10 traveling on the circulation route has a time distance from the base of less than a reference value (such as t). The controller 23 may then withhold introduction of the other vehicle 10 until there is no longer a vehicle 10 with a time distance from the base of less than the reference value.

For example, an embodiment in which a general purpose computer functions as the server 20 according to the above embodiment can also be implemented. Specifically, a program in which processes for realizing the functions of the server 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An operation management method for a plurality of circulating buses, each circulating bus being introduced into a circulation route from a base and returning to the base to be switched with another circulating bus after traveling a specified number of laps, the operation management method comprising:
storing, by a server, an operation schedule of the plurality of circulating buses;
monitoring, by the server, a status of the plurality of circulating buses;
judging, by the server, whether a first circulating bus traveling on the circulation route is on a final lap in the specified number of laps when the first circulating bus passes a second circulating bus traveling on the circulation route; and
revising, by the server, the operation schedule to increase the number of circulating buses by introducing a third circulating bus into the circulation route from the base when it is judged that the first circulating bus is on the final lap.

2. The operation management method of claim 1, wherein the operation schedule before revision is determined so that the number of circulating buses traveling on the circulation route is maintained at a specified number a, where a is a natural number equal to or greater than two, and
the revised operation schedule is determined so that the number of circulating buses traveling on the circulation route is maintained at a+1.

3. The operation management method of claim 1, wherein the operation schedule before revision is determined so that a circulating buses traveling on the circulation route are arranged at substantially equal intervals on the circulation route, where a is a natural number equal to or greater than two, and
the revised operation schedule is determined so that a+1 circulating buses traveling on the circulation route are arranged at substantially equal intervals on the circulation route by a point at which a predetermined time has elapsed from a timing at which the third circulating bus is introduced into the circulation route.

4. The operation management method of claim 1, further comprising notifying, by the server, a terminal apparatus provided at one or more bus stops located on the circulation route of an increase in the number of circulating buses traveling on the circulation route when the operation schedule is revised.

5. The operation management method of claim 1, wherein the operation schedule before revision is determined so that a plurality of circulating buses is not on the same lap simultaneously, except for a certain time period from an operation start time of a transportation service that uses the plurality of circulating buses.

6. The operation management method of claim 1, wherein the operation schedule before revision is determined so that switching between a circulating bus that has completed the specified number of laps and another circulating bus occurs once in a specified period.

7. The operation management method of claim 1, further comprising switching, by the server, the operation schedule assigned to the first circulating bus with the operation schedule assigned to the second circulating bus when it is judged that the first circulating bus is not on the final lap.

8. A server for managing a plurality of circulating buses, each circulating bus being introduced into a circulation route from a base and returning to the base to be switched with another circulating bus after traveling a specified number of laps, the server comprising a controller configured to:
store an operation schedule of the plurality of circulating buses;
monitor a status of the plurality of circulating buses;
judge whether a first circulating bus traveling on the circulation route is on a final lap in the specified number of laps when the first circulating bus passes a second circulating bus traveling on the circulation route; and
revise the operation schedule to increase the number of circulating buses by introducing a third circulating bus into the circulation route from the base when it is judged that the first circulating bus is on the final lap.

9. The server of claim 8, wherein the operation schedule before revision is determined so that the number of circulating buses traveling on the circulation route is maintained at a specified number a, where a is a natural number equal to or greater than two, and the revised operation schedule is determined so that the number of circulating buses traveling on the circulation route is maintained at a+1.

10. The server of claim 8, wherein the operation schedule before revision is determined so that a circulating buses traveling on the circulation route are arranged at substantially equal intervals on the circulation route, where a is a natural number equal to or greater than two, and
the revised operation schedule is determined so that a+1 circulating buses traveling on the circulation route are arranged at substantially equal intervals on the circulation route by a point at which a predetermined time has elapsed from a timing at which the third circulating bus is introduced into the circulation route.

11. The server of claim 8, further comprising:
a communication interface, wherein
the controller is configured to notify, via the communication interface, a terminal apparatus provided at one or more bus stops located on the circulation route of an increase in the number of circulating buses traveling on the circulation route when the operation schedule is revised.

12. The server of claim 8, wherein the operation schedule before revision is determined so that a plurality of circulating buses is not on the same lap simultaneously, except for a certain time period from an operation start time of a transportation service that uses the plurality of circulating buses.

13. The server of claim 8, wherein the operation schedule before revision is determined so that switching between a circulating bus that has completed the specified number of laps and another circulating bus occurs once in a specified period.

14. The server of claim 8, wherein the controller is configured to switch the operation schedule assigned to the first circulating bus with the operation schedule assigned to the second circulating bus when it is judged that the first circulating bus is not on the final lap.

15. A system comprising a plurality of circulating buses, each circulating bus being introduced into a circulation route from a base and returning to the base to be switched with another circulating bus after traveling a specified number of laps, and a server for managing operation of the plurality of circulating buses, wherein
the server is configured to store an operation schedule of the plurality of circulating buses;
the plurality of circulating buses operates in accordance with the operation schedule;
the server is configured to
monitor a status of the plurality of circulating buses;
judge whether a first circulating bus traveling on the circulation route is on a final lap in the specified number of laps when the first circulating bus passes a second circulating bus traveling on the circulation route; and
revise the operation schedule to increase the number of circulating buses by introducing a third circulating bus into the circulation route from the base when it is judged that the first circulating bus is on the final lap; and
the plurality of circulating buses operates in accordance with the revised operation schedule.

16. The system of claim 15, wherein the operation schedule before revision is determined so that the number of circulating buses traveling on the circulation route is maintained at a specified number a, where a is a natural number equal to or greater than two, and
the revised operation schedule is determined so that the number of circulating buses traveling on the circulation route is maintained at a+1.

17. The system of claim 15, wherein the operation schedule before revision is determined so that a circulating buses traveling on the circulation route are arranged at substantially equal intervals on the circulation route, where a is a natural number equal to or greater than two, and
the revised operation schedule is determined so that a+1 circulating buses traveling on the circulation route are arranged at substantially equal intervals on the circulation route by a point at which a predetermined time has elapsed from a timing at which the third circulating bus is introduced into the circulation route.

18. The system of claim 15, wherein the server is configured to notify a terminal apparatus provided at one or more bus stops located on the circulation route of an increase in the number of circulating buses traveling on the circulation route when the operation schedule is revised.

19. The system of claim 15, wherein the operation schedule before revision is determined so that switching between a circulating bus that has completed the specified number of laps and another circulating bus occurs once in a specified period.

20. The system of claim 15, wherein the server is further configured to switch the operation schedule assigned to the first circulating bus with the operation schedule assigned to the second circulating bus when it is judged that the first circulating bus is not on the final lap.
